(19) United States
(12) Patent Application Publication
(10) Pub. No.: US 2007/0143594 A1
(43) Pub. Date: Jun. 21, 2007

(54) Method for distributing digital data and burning them on a DVD, client device and remote server associated

(76) Inventors: Yan-Mei Yang-Talpin, Saint Gregoire (FR); Yves Maetz, Melesse (FR); Olivier Heen, Domloup (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/312,821

(22) Filed: Dec. 20, 2005

(51) Int. Cl. H04L 9/00

(52) U.S. Cl. 713/155

(57) ABSTRACT

The invention is related to a method for burning digital data representative of a multimedia content on a secure disc. The multimedia content is intended to be downloaded from a remote server to a client device carrying out the burning on the secure disc. The secure disc contains a first encryption key. The method comprises the following steps: (a) retrieving the first encryption key from the secure disc; (b) transmitting to the remote server the first encryption key and an identifier of the multimedia content; (c) receiving from the remote server at least a second encryption key encrypted with the first encryption key and the multimedia content scrambled with the second encryption key; and (d) burning the second encryption key and the scrambled multimedia content on the secure disc containing the encrypted first encryption key, by the client device.

### TECHNICAL FIELD OF THE INVENTION

The invention relates generally to a method for burning digital data representative of a multimedia content on a secure digital video disc, the digital data being downloaded from a remote server.

### BACKGROUND OF THE INVENTION

Copyright multimedia contents can be stored on a secure digital video disc to prevent their illegal copy.

Copyright multimedia contents can be requested, paid and downloaded from a content provider through Internet. In this case, the copyright multimedia contents are scrambled by the content provider and transmitted through Internet to the purchaser's computer in a scrambled form along with encryption keys. These encryption keys contain an identifier of the purchaser's computer so that the multimedia content can only be shown, listened or presented from this computer.

After downloading on a purchaser's computer, these copyright multimedia contents can be copied on a writable support. However, a computer different from the purchaser's computer cannot descramble the multimedia content stored on this writable support since its identifier is different from the identifier used to build the encryption keys which are employed to scramble the multimedia content.

Besides, known devices are adapted to download a multimedia content from a content provider through Internet, to scramble it and to burn it on a secure digital video disc.

However, these devices are expensive because they require a great number of high level security systems to exclude any possibility of piracy of their scrambler module.

In this context, there is a need to develop a cheaper method and device for burning on a secure digital video disc multimedia contents purchased and downloaded from a content provider and in which the resulting burnt multimedia content could be rendered on any legacy player, but a physical copy of the burnt secure digital video disc would not be rendered on any legacy player.

### SUMMARY OF THE INVENTION

In a first aspect, the invention relates to a method for burning digital data representative of a multimedia content on a secure disc containing a first encryption key. The multimedia content is intended to be downloaded from a remote server through a distribution network to a client device carrying out the burning on the secure disc. The method comprises the following steps performed by the client device:
retrieving the first encryption key from the secure disc;
transmitting to the remote server the first encryption key and an identifier of the multimedia content intended to be downloaded;
receiving from the remote server at least one second encryption key encrypted with the first encryption key and the multimedia content scrambled with the or each second encryption key; and
burning the or each second encryption key and the scrambled multimedia content received from the remote server on the secure disc containing the encrypted first encryption key.

In a first preferred embodiment, the method further comprises a step of establishing a secure authenticated channel between the client device and the remote server previous to the step of transmitting the first encryption key and the identifier of the multimedia content. Preferably, the first and the second encryption keys, the identifier of the multimedia content and the multimedia content are transmitted only through this established secure authenticated channel.

In a second preferred embodiment, the secure disc contains an encrypted first encryption key pre-burnt on the secure disc and the step of retrieving the first encryption key comprises:
reading the encrypted first encryption key on the secure disc; and
decrypting the encrypted first encryption key with the help of a master key stored in a memory of the client device to retrieve the first encryption key of the secure disc.

In another particular embodiment of the invention, the first encryption key has a low probability of being common to two different secure discs.

In yet another embodiment, the first encryption key is a unique number which is only pre-burnt on one unique specific secure disc.

In a second aspect, the invention relates to a method for distributing digital data representative of a multimedia content able to be downloaded from a remote server to a client device through a distribution network. The multimedia content is intended to be burnt by the client device on a secure disc containing a first encryption key. The method comprises the following steps performed by the remote server:
receiving from the client device the first encryption key retrieved from the secure disc and an identifier of the multimedia content intended to be burnt;
generating at least one second encryption key;
scrambling the multimedia content intended to be burnt with the or each second encryption key;
encrypting the or each second encryption key with the first encryption key; and
transmitting to the client device the scrambled multimedia content and the or each encrypted second encryption key for burning them on the secure disc.

In a third aspect, the invention relates to a remote server for distributing digital data representative of a multimedia content to a client device through a distribution network, the multimedia content being intended to be burnt on a secure disc containing a first encryption key. The server preferably comprises:
a network interface adapted to receive from the client device the first encryption key retrieved from the secure disc and an identifier of the multimedia content intended to be burnt;
a random number generator adapted to generate at least one second encryption key;
a scrambler module for scrambling the multimedia content intended to be burnt with the or each second encryption key; and
an encryption module for encrypting the or each second encryption key with the first encryption key.

The network interface is adapted to transmit to the client device the scrambled multimedia content and the or each encrypted second encryption key through the distribution network for burning them on the secure disc.

In a preferred embodiment of the remote server, the network interface is able to build up a secure authenticated channel with a client device to receive the identifier of the multimedia content intended to be burnt and the first encryption key and to transmit the scrambled multimedia content intended to be burnt and the or each encrypted second encryption key.

In a fourth aspect, the invention relates to a client device for burning digital data representative of a multimedia content on a secure disc, the disc containing a first encryption key and the multimedia content being intended to be downloaded from a remote server through a distribution network. The client device preferably comprises:
a reader/burner device for retrieving the first encryption key from the secure disc and
a network interface for transmitting to the remote server the first encryption key and an identifier of the multimedia content intended to be downloaded.

The network interface is adapted to receive at least a second encryption key encrypted with the first encryption key and the multimedia content downloaded from the remote server, the multimedia content being scrambled with the or each second encryption key; and the reader/burner device is adapted to burn the or each encrypted second encryption key and the scrambled multimedia content received from the remote server on the secure disc containing the first encryption key.

In a preferred embodiment of the client device, the secure disc contains an encrypted first encryption key pre-burnt on the secure disc, and the reader/burner device is adapted to read the encrypted first encryption key on the secure disc; the client device comprising a memory storing a master key and a decryption module to decrypt the encrypted first encryption key with the help of the master key to retrieve the first encryption key of the secure disc.

These and other aspects of the method will be apparent from the following description, drawings and from the claims.

### BRIEF DESCRIPTION OF THE DRAWINGS

FIG. 1 is a schematic representation of a system adapted to generate secure CSS blank DVD used in the method according to the invention.

FIG. 2 is a schematic representation of a system used for implementing the method according to the invention.

FIG. 3 is a schematic representation showing the exchanges between a remote server, a client device and a content provider belonging to the system illustrated in FIG. 2.

### DETAILED DESCRIPTION

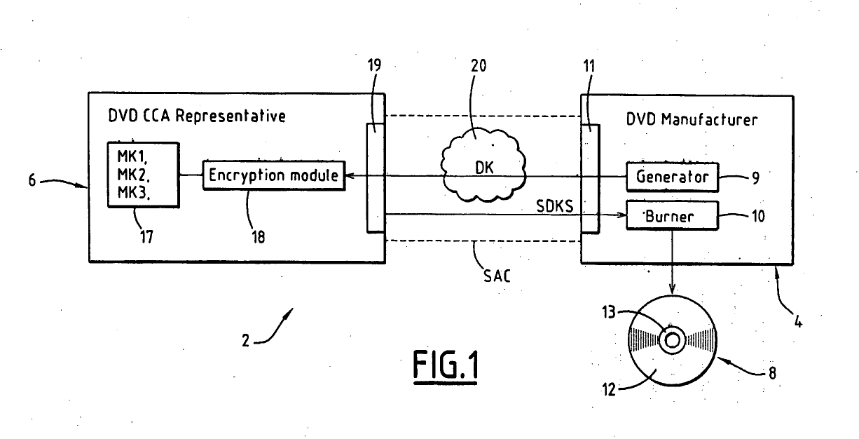

Referring to FIG. 1, a system 2 adapted to generate secure blank DVD, is illustrated.

This system 2 comprises a manufacturer 4 of Digital Video Disc DVD) adapted to securely exchange data with a DVD Copy Control Authority (CCA) representative 6 to produce secure blank DVD 8.

In the illustrative embodiment hereunder described, the produced blank DVD 8 is protected according to a known protection system named “Content Scrambling System” (CSS).

The DVD Manufacturer 4 is thus a CSS DVD manufacturer. It comprises a random number generator 9 for generating encryption keys DK, a burner 10 adapted to burn data on a DVD 8 and a network interface 11 for exchanging data with the CCA representative 6.

The produced blank DVD 8 comprises a blank data area 12 on which multimedia content MC can be burnt by a user's burner and a lead-in area 13 on which a secure disc key set SDKs is burnt by the DVD manufacturer's burner 10 before the delivery of the blank DVD 8. This secure disc key set can be seen as an encrypted representation of a disc key DK, as explained later.

According to the invention, each disc key DK is unique and is specific to the particular DVD 8 on which the corresponding secured disc key set is burnt. So, one disc key DK is associated with only one DVD.

In variant, a certain number of prerecorded DVD with the same pre-recorded secure disc key set SDKs, i.e. associated with the same disk key DK, can be accepted if the probability that a same user acquires two identical pre-recorded DVDs during a time period is low and the probability that two users in the same geographical zone acquire identical prerecorded DVDs is also low. For; example, a probability of less than 1% may be considered low. Allowing low probability reduces the production cost for the DVD manufacturer while maintaining fair security for the overall system.

The network interface 11 is adapted to send the disc key DK generated by the generator 9 to the CCA representative 6 and to receive in response the secure disc key set SDKs corresponding to the disc key DK.

The CSS DVD CCA representative 6 includes a memory 17 for securely storing a set of master keys MK1, MK2, MK3, an encryption module 18 connected to the memory 17 and to a network interface 19. Master keys may also be referred to as “manufacturer keys” in literature.

The encryption module 18 is able to encrypt the disc key DK received from the DVD manufacturer 4 with each master key of the set of master keys MK1, MK2, MK3 etc. The set of encrypted disc keys SDKs obtained from the encryption of one disc key DK with all master keys MK1, MK2, MK3 is usually called a secure disc key set SDKs. This is the information written in the lead-in area 13 of blank discs by the DVD manufacturer 4.

The network interface 11 of the DVD Manufacturer and the network interface 19 of the representative 6 are able to establish a Secure Authenticated Channel SAC through a distribution network 20.

The secure authenticated channel SAC can be established through either a standard protocol like for example the Secure Socket Layer SSL protocol with authentication of both peers or a proprietary protocol like the SmartRight™ SAC protocol disclosed in international patent application No. PCT/EP04/052722. It can be based on standard Public Key Infrastructure (PKI) or on other techniques.

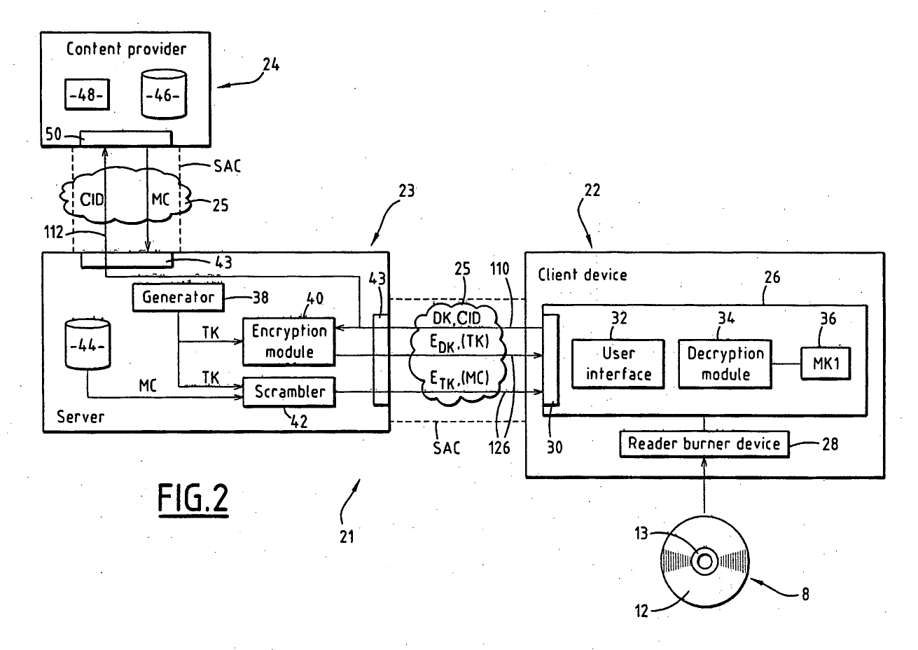

Referring to FIG. 2, the system 21 for implementing the method according to the invention comprises a client device 22, a remote server 23 and a multimedia content provider 24, each adapted to exchange data through a distribution network 25, for example the Internet network.

The client device 22 is for example composed of a computer 26 connected to a particular reader/burner device 28.

The computer 26 contains a network interface 30 and a user interface 32 such as keyboard, screen and mouse to request and to receive multimedia contents MC from the remote server 23, through the distribution network 25.

The computer 26 comprises further a decryption module 34 connected to a memory 36 storing at least one master key. One valid master key MK1 is used to decrypt the secure disc key set SDKs burnt on the lead-in area 13 of the secure DVD 8.

The memory 36 is secured with state of the art protection system. Examples of such systems are currently implemented in legacy DVD players.

The reader/burner device 28 is able to read the lead-in area 13 of the DVD 8 and to burn data on its data area 12.

The remote server 23 comprises a random number generator 38 linked to an encryption module 40 and to a scrambler module 42. The scrambler module 42 is adapted to scramble the requested multimedia content MC before transmission to the client device 22.

The remote server 23 also contains a network interface 43 and a database 44 for temporally storing the requested multimedia content MC.

The network interface 30 of the client device and the network interface 43 of the remote server are adapted to establish a secure authenticated channel SAC.

The establishment of secure authenticated channel SAC requires the mutual authentication of the remote server 23 and of the client device 22. The remote server 23 is authenticated to be sure that the multimedia content MC comes from an authorized source. The secure authenticated channel. SAC thus prevents from burning illegal content.

The client device 22 is authenticated to prove his compliance to the remote server 23 so that the remote server knows that the client device 22 will not redistribute the multimedia content MC in an unauthorised manner.

The content provider 24 contains a database 46 which stores multimedia contents proposed for burning, a processor 48 and a network interface 50.

The network interface 43 of the remote server and the network interface 50 of the content provider are adapted to establish a secure authenticated channel SAC.

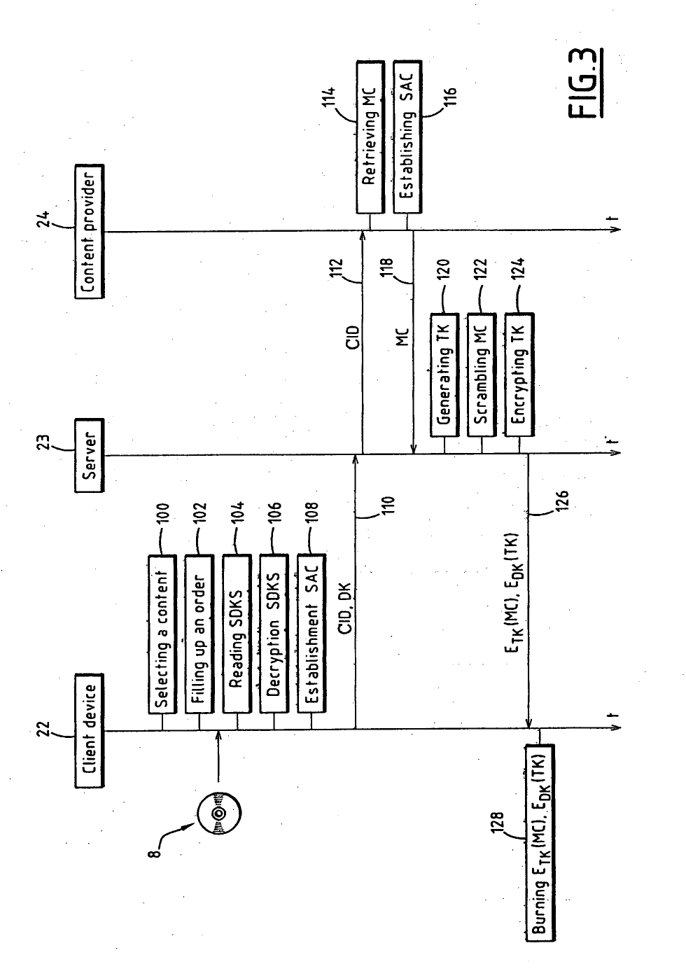

Referring to FIG. 3, at an initial step 100, a user wishing to buy a multimedia content MC to be burnt on a CSS secure blank DVD 8, connects the client device 22 to the content provider 24, through the distribution network 25 and the remote server 23. Then, he selects for example a multimedia content MC among a set of multimedia contents proposed for burning and stored in the database 46 of the content provider.

At step 102, the user fills up a content request indicating the identifier CID of the chosen multimedia content with the help of the user interface 32. The user inserts a CSS secure blank DVD 8 in the reader/burner device 28 of the client device 22.

At step 104, the reader/burner device 28 reads the secure disc key set SDKs pre-burnt on the lead-in area 13 of the DVD 8.

At step 106, the decryption module 34 decrypts the secure disc key set SDKs read by the reader/burner device 28 with the help of the master key MK1 stored in the memory 36 to retrieve the disc key DK associated to the DVD 8 bought by the user.

In the same time, the decryption module 34 checks whether the blank DVD 8 is compliant. When the disc key DK of the blank DVD 8 cannot be decrypted then it means that the blank DVD 8 is not compliant and cannot be burnt. The client device 22 informs the user of this compliance problem through the user interface 32.

At step 108, the remote server 23 and the client device 22 establish a Secure Authenticated. Channel SAC through which they can securely exchange data. Once authenticated, the remote server 23 and the client device 22 exchange data protected in integrity and/or in confidentiality.

At step 110, the client device 22 transmits the disc key DK specific of the bought blank DVD 8 and the filled up content request (containing the identifier CID) to the remote server 23, through the secure authenticated channel SAC.

If an identical disc key DK has already been received by the remote server 23, the remote server transmits an error message to the client device 22 and the method ends.

At step 112, the identifier CID of the requested multimedia content MC is transmitted from the remote server 23 to the content provider 24, through the distribution network 25.

At step 114, the processor 48 retrieves the digital data representative of the requested multimedia content MC in the database 46 from its identifier CID.

At step 116, the content provider 24 establishes a secure authenticated channel SAC with the remote server 23.

At step 118, the content provider 24 transmits the multimedia content MC to the remote server 23. The multimedia content MC is then temporally stored in the database 44.

At step 120, the generator 38 produces a random number to constitute a Title key TK and sends it to the scrambler module 42 and to the encryption module 40.

At step 122, the multimedia content MC is transmitted to the scrambler module 42 which scrambles it using the Title key TK generated at step 120.

At step 124, the encryption module 40 encrypts the title key TK with the help of the disc key DK received from the client device 22 and corresponding to the secure blank DVD 8 introduced into the reader/burner device 28.

Then, at step 126, the scrambled multimedia content E_{TK}(MC) and the encrypted title key E_{DK}(TK) are transferred through the secure authenticated channel SAC to the client device 22.

Finally, at step 128, the scrambled multimedia content E_{TK}(MC) and the encrypted title key E_{DK}(TK) are burnt on the data area 12 of the secure blank DVD 8 by the reader/burner device 28 of the client device.

Steps 120 to 128 can be repeated for several pieces of multimedia content MC, a new title key TK being generated for each piece of content MC (e.g. in case of film burning, one TK can be generated for the movie itself and one TK can be generated for the making-of).

According to the invention, multimedia content and encryption keys should be exchanged securely between the client device 22, the remote server 23 and the content provider 24, for example through a secure authenticated channel SAC.

Since the client device stores only one or a few master key(s) MK1 and does not comprise a scrambler module or a title key generator, the client device comprises only a protection system of a memory which is easier to build and is cheaper than a protection system of a processor.

In the here above description, the Content Scrambling System (CSS) is used to protect the multimedia content burnt on DVD. In variant, other copy protection systems dedicated to DVD or to other storage media can also be used such as for example the Content Protection for Prerecorded Media (CPPM), the Content Protection for Recordable Media (CPRM), the Blue-ray Disc Copy Protection System (BD-CPS) or the Vidi System for DVD+R/+RW discs.

In variant, the multimedia content MC flowing from the remote server 23 to the client device 22 is super-scrambled over the initial scrambling, e.g. CSS, using a possibly different scrambling algorithm, e.g. AES (for Advanced Encryption Standard). In this case, the client device 22 removes the super-scrambling before burning the initially scrambled multimedia content MC on the data area of the DVD 8.

In variant, the remote server 23 comprises the database 46 storing digital data representative of multimedia contents proposed for burning and a processor for retrieving the multimedia content from the database with the help of the identifier CID of the multimedia content. In this case, the remote server does not exchange data with a content provider.

Advantageously, the multimedia content is delivered securely.

Advantageously, the client device does not require a more secure environment than legacy DVD players.

Advantageously, the content is scrambled within the server environment which is usually more secure than the client environment.

Advantageously, the client device does not need to scramble the content and therefore does not require much processing capabilities.

Advantageously, the prerecording of a disc key DK (in a secure disc key set) unique to each DVD (or a disc key having a low probability of being common for two different DVD) prevents from attack using bit-to-bit copy. This attack consists in literal copy of the data area (protected by a first disc key DK1) from a first burnt DVD comprising a secure disc key set SDKs1 onto a second DVD. As the second DVD contains a different secure disc key set SDKs2, then a legacy player cannot recover the disc key DK1 and therefore cannot play back the copy.

Advantageously, a different title key TK can be used for each burnt DVD and content. This may facilitate content tracking.

What is claimed is:

1. A method for burning digital data representative of a multimedia content on a secure disc containing a first encryption key, the multimedia content being intended to be downloaded from a remote server through a distribution network to a client device carrying out the burning on the secure disc, wherein the method comprises the following steps performed by the client device:
retrieving the first encryption key from the secure disc;
transmitting to the remote server the first encryption key and an identifier of the multimedia content intended to be downloaded;
receiving from the remote server at least one second encryption key encrypted with the first encryption key and the multimedia content scrambled with the or each second encryption key; and
burning the or each second encryption key and the scrambled multimedia content received from the remote server on the secure disc containing the encrypted first encryption key.

2. The method according to claim 1, wherein it comprises a step of establishing a secure authenticated channel between the client device and the remote server previous to the step of transmitting the first encryption key and the identifier of the multimedia content and wherein the first and the second encryption keys, the identifier of the multimedia content and the multimedia content are transmitted only through the established secure authenticated channel.

3. The method according to claim 1, wherein the secure disc contains an encrypted first encryption key pre-burnt on the secure disc, the step of retrieving the first encryption key comprising:
reading the encrypted first encryption key on the secure disc; and
decrypting the encrypted first encryption key with the help of a master key stored in a memory of the client device to retrieve said first encryption key of the secure disc.

4. The method according to claim 1, wherein the first encryption key is a disc key and the or each second encryption key is a title key.

5. The method according to claim 1, wherein the first encryption key has a low probability of being common to two different secure discs.

6. The method according to claim 5, wherein the first encryption key is a unique number which is only pre-burnt on one unique specific secure disc.

7. A method for distributing digital data representative of a multimedia content able to be downloaded from a remote server to a client device through a distribution network, the multimedia content being intended to be burnt by the client device on a secure disc containing a first encryption key, wherein it comprises the following steps performed by the remote server:
receiving from the client device the first encryption key retrieved from the secure disc and an identifier of the multimedia content intended to be burnt;
generating at least one second encryption key;
scrambling the multimedia content intended to be burnt with the or each second encryption key;
encrypting the or each second encryption key with the first encryption key; and
transmitting to the client device the scrambled multimedia content and the or each encrypted second encryption key for burning them on the secure disc.

8. A remote server for distributing digital data representative of a multimedia content to a client device through a distribution network, the multimedia content being intended to be burnt on a secure disc containing a first encryption key, wherein it comprises:
a network interface adapted to receive from the client device the first encryption key retrieved from the secure disc and an identifier of the multimedia content intended to be burnt;
a random number generator adapted to generate at least one second encryption key;
a scrambler module for scrambling the multimedia content intended to be burnt with the or each second encryption key; and
an encryption module for encrypting the or each second encryption key with the first encryption key;
the network interface being adapted to transmit to the client device the scrambled multimedia content and the or each encrypted second encryption key through the distribution network for burning them on the secure disc.

9. The remote server according to claim 8, wherein the network interface is able to build up a secure authenticated channel with a client device to receive the identifier of the multimedia content intended to be burnt and the first encryption key and to transmit the scrambled multimedia content intended to be burnt and the or each encrypted second encryption key.

10. A client device for burning digital data representative of a multimedia content on a secure disc containing a first encryption key, the multimedia content being intended to be downloaded from a remote server through a distribution network, wherein the client device comprises:
a reader/burner device for retrieving the first encryption key from the secure disc;
a network interface for transmitting to the remote server the first encryption key and an identifier of the multimedia content intended to be downloaded;
the network interface being adapted to receive at least a second encryption key encrypted with the first encryption key and the multimedia content downloaded from the remote server, the multimedia content being scrambled with the or each second encryption key; and
the reader/burner device being adapted to burn the or each encrypted second encryption key and the scrambled multimedia content received from the remote server on the secure disc containing the first encryption key.

11. The client device according to claim 10, wherein the secure disc contains an encrypted first encryption key pre-burnt on the secure disc, and wherein the reader/burner device is adapted to read the encrypted first encryption key on the secure disc; the client device comprising a memory storing a master key and a decryption module to decrypt the encrypted first encryption key with the help of the master key to retrieve the first encryption key of the secure disc.
